(19) United States
(12) Patent Application Publication
(10) Pub. No.: US 2020/0348799 A1
(43) Pub. Date: Nov. 5, 2020

(54) IMPLEMENTATION METHOD AND APPARATUS OF SYSTEM USER INTERFACE

(71) Applicant: AUTEL INTELLIGENT TECHNOLOGY CORP., LTD., Shenzhen (CN)

(72) Inventor: Yuhua LIN, Shenzhen (CN)

(21) Appl. No.: 16/821,119

(22) Filed: Mar. 17, 2020

Related U.S. Application Data
(63) Continuation of application No. PCT/CN2018/107662, filed on Sep. 26, 2018.

(30) Foreign Application Priority Data
Sep. 27, 2017 (CN) 201710890827.8

(51) Int. Cl. G06F 3/0481

(52) U.S. Cl. CPC G06F 3/0481

(57) ABSTRACT

The present invention discloses an implementation method and apparatus of a system user interface, where the method includes: detecting a current status of hardware or software in a terminal; and adaptively adjusting a navigation bar of the system user interface according to the current status of the hardware or the software in the terminal. In embodiments of the present invention, adaptively adjusting the navigation bar of the system user interface makes use of the system user interface more convenient and improves user experience.

This application is a continuation application of International Application No. PCT/CN2018/107662, filed on Sep. 26, 2018, which claims priority of Chinese Patent Application No. 201710890827.8, filed on Sep. 27, 2017, which is incorporated herein by reference in its entirety.

### BACKGROUND

### Technical Field

The present application relates to the field of information technology, and in particular, to an implementation method and apparatus of a system user interface.

### Related Art

In an intelligent terminal, a system user interface (SystemUI) is an important interface of interaction between a user and a machine, is in a very close relationship with the user, and is an important aspect of user experience. For a mobile phone, the SystemUI generally includes: a status bar (StatusBar) and a navigation bar (NavigationBar). For a tablet computer (Tablet) or a television (TV), the SystemUI is a combined bar (CombinedBar), including a StatusBar and a NavigationBar.

In a standard Android (android) system, the navigation bar of the SystemUI displays only three keys, namely, Back (return), Home (homepage), and Recents (recently run APP), which have relatively simple functions.

### SUMMARY

To resolve the foregoing technical problems, the present invention provides an implementation method and apparatus of a system user interface, to facilitate user operations and improve user experience.

To achieve an objective of the present invention, an embodiment of the present invention provides an implementation method of a system user interface, including:

detecting a current status of hardware or software in a terminal; and

adaptively adjusting a navigation bar of the system user interface according to the current status of the hardware or the software in the terminal.

Optionally, the adaptively adjusting a navigation bar of the system user interface includes at least one of the following:

displaying or hiding the navigation bar;

displaying or hiding one or more navigation keys in the navigation bar; and

displaying different statuses of the navigation key.

Optionally, the method further includes:

receiving an instruction of selecting a navigation key in the navigation bar, and starting a corresponding application, performing a corresponding service or displaying a corresponding dialog box according to the selected navigation key; or

receiving an instruction of selecting a navigation key in the navigation bar, and starting a corresponding application, performing a corresponding service or displaying a corresponding dialog box according to the selected navigation key and an operation mode.

Optionally, the operation mode includes a click and a long press.

Optionally, more than two navigation keys in the navigation bar have a mutually exclusive relationship, where the method further includes:

operating only one of the navigation keys having the mutually exclusive relationship at a time.

Optionally, at least one of the navigation keys in the navigation bar is related to a connection status of an external device of the terminal, and the adaptively adjusting a navigation bar of the system user interface according to the current status of the hardware or the software in the terminal includes:

correspondingly changing a display status of the navigation key related to the connection status of the external device when the connection status of the external device changes.

Optionally, the navigation key includes at least one of the following:

a browser key, a camera & screenshot key, a brightness & volume key, a diagnosis homepage key, a vehicle communication interface VCI key, a diagnosis key, a repair and maintenance service key, a guard against theft key and a tire pressure monitoring system TPMS key.

An embodiment of the present invention further provides an implementation apparatus of a system user interface, including: a memory, a processor and a computer program stored in the memory and executable on the processor, where when executing the program, the processor implements the following steps:

detecting a current status of hardware or software in a WI urinal; and

adaptively adjusting a navigation bar of the system user interface according to the current status of the hardware or the software in the terminal.

Optionally, when executing the program, the processor adaptively adjusts the navigation bar of the system user interface by adopting at least one of the following manners:

displaying or hiding the navigation bar;

displaying or hiding one or more navigation keys in the navigation bar; and

displaying different statuses of the navigation key.

Optionally, when executing the program, the processor further implements:

receiving an instruction of selecting a navigation key in the navigation bar, and starting a corresponding application, performing a corresponding service or displaying a corresponding dialog box according to the selected navigation key; or

receiving an instruction of selecting a navigation key in the navigation bar, and starting a corresponding application, performing a corresponding service or displaying a corresponding dialog box according to the selected navigation key and an operation mode.

Optionally, more than two navigation keys in the navigation bar have a mutually exclusive relationship, where when executing the program, the processor further implements:

operating only one of the navigation keys having the mutually exclusive relationship at a time.

Optionally, at least one of the navigation keys in the navigation bar is related to a connection status of an external device of the terminal, and when executing the program, the processor further implements:

correspondingly changing a display status of the navigation key related to the connection status of the external device when the connection status of the external device changes.

An embodiment of the present invention further provides an implementation apparatus of a system user interface, a computer-readable storage medium, storing a computer-executable instruction, where the computer-executable instruction is used to perform the steps of the implementation method of a system user interface.

An embodiment of the present invention includes: detecting a current status of hardware or software in a terminal; and adaptively adjusting a navigation bar of the system user interface according to the current status of the hardware or the software in the terminal. In this embodiment of the present invention, adaptively adjusting the navigation bar of the system user interface makes use of the system user interface more convenient and improves user experience. Compared with the prior art, in an embodiment of the present invention, more navigation keys are adopted. Instead of being clicked step by step, related applications can be directly jumped to through the navigation keys, so that an operation is more convenient and efficient. Furthermore, a running status of related software can be reflected more directly by displaying different statuses of the navigation key. For example, when a diagnosis APP is run in the background, a user can determine more easily which diagnosis-related function is currently used, for example, whether diagnosis or a repair and maintenance service is performed, or whether TPMS diagnosis or a guard against theft key-cutting function is used. Additionally, only one of the navigation keys having the mutually exclusive relationship can be operated at a time, so that a software operation is more simple and comprehensible.

Other features and advantages of the present invention described in the following specification, and some of the features and advantages are apparent from the specification, or learned by implementing the present invention. The objectives and other advantages of the present invention can be implemented and obtained by using a specified structure in the specification, the claims and the accompanying drawings.

### BRIEF DESCRIPTION OF THE DRAWINGS

Accompanying drawings are provided for a further understanding on technical solutions of the present invention, and constitute a part of a specification. The accompanying drawings and embodiments of the present application are used to explain the technical solutions of the present invention and do not limit the technical solutions of the present invention.

FIG. 1 is a flowchart of an implementation method of a system user interface according to an embodiment of the present invention;

FIG. 2 is a main interface of a terminal according to application example of the present invention;

FIG. 3 is a flowchart of displaying a layout of a navigation bar according to an application example of the present invention;

FIG. 4 is a flowchart of an operation of clicking a VCI navigation key according to an application example of the present invention;

FIG. 5 is a schematic diagram of status changing of a corresponding navigation key when a VCI connection status changes according to an application example of the present invention;

FIG. 6 is a flowchart of clicking a navigation key to start an application or a service according to an application example of the present invention;

FIG. 7 is a flowchart of clicking a navigation key to open a dialog box according to an application example of the present invention;

FIG. 8 is a flowchart of pressing and holding a navigation key according application example of the present invention;

FIG. 9 is a flowchart of clicking one of diagnosis-related navigation keys according to an application example of the present invention;

FIG. 10 is a schematic diagram of status changing of a corresponding navigation key when a diagnosis application is killed according to an application example of the present invention; and

FIG. 11 is a schematic diagram of an implementation apparatus of a system user interface according to an embodiment of the present invention.

### DETAILED DESCRIPTION

To make objectives, technical solutions and advantages of the present invention more comprehensible, embodiments of the present invention are described below in detail with reference to the accompanying drawings. It should be noted that the embodiments of the present application and features in the embodiments can be randomly combined with each other provided that there is no conflict.

Steps shown in flowcharts of the accompanying drawings can be performed in a computer system such as a set of computer-executable instructions. Furthermore, a logical order is shown in the flowchart, but in some cases, an order different from the logical order can be used to perform the shown or described steps.

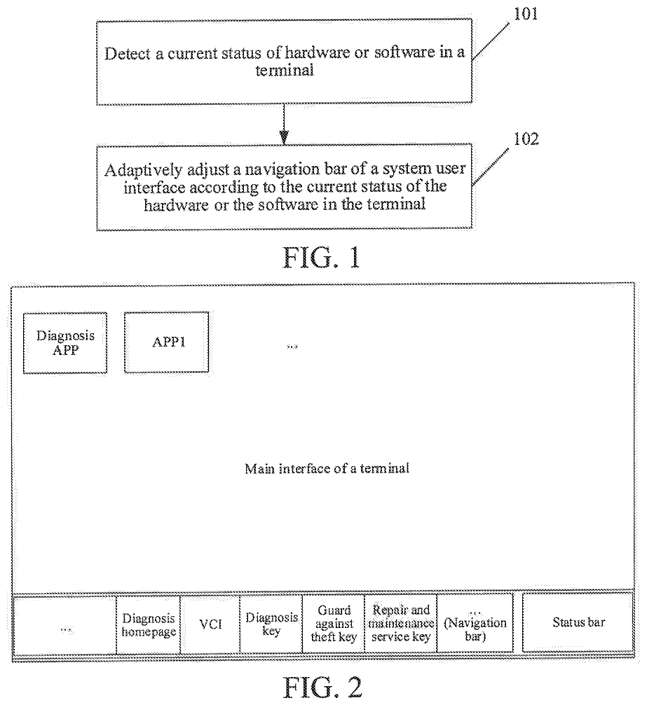

To make a user operation more convenient and improve user experience, as shown in FIG. 1, an embodiment of the present invention provides an implementation method of a system user interface, including:

Step 101. Detect a current status of hardware or software in a terminal.

Step 102. Adaptively adjust a navigation bar of a system user interface according to the current status of the hardware or the software in the terminal.

In this embodiment of the present invention, adaptively adjusting the navigation bar of the system user interface makes use of the system user interface more convenient and improves user experience.

In this embodiment of the present invention, the navigation bar includes one or more navigation keys. In this case, the navigation key is an icon key that can guide a user to enter a target application quickly. Using a SystemUI capable of directly reflecting a diagnostic status of a vehicle as an example, in addition to including three traditional keys, namely, Back (return), Home (homepage), and Recents (recently run APP), for example, a browser key (Browser), a camera & screenshot key (Camera&Shoot), a brightness & volume (Brightness&Volume) key, a diagnosis homepage key (diagnosis homepage), a VCI (Vehicle Communication Interface) key, a diagnosis key (Diagnose), a guard against theft key (Guard Against Theft), a repair and maintenance service key (Service), a tire pressure monitoring system (TPMS) key and the like may be further included.

In this embodiment of the present invention, the terminal may be a mobile terminal such as a mobile phone terminal, a tablet computer, a vehicle diagnosis instrument, or a notebook computer, and may alternatively be a fixed terminal such as a desktop computer.

FIG. 2 is a main interface of a terminal according to an application example of the present invention. Because this example mainly reflects a diagnostic status of a vehicle, a diagnosis APP is displayed in the figure, in which a combined bar (an interactive interface of a system) of a SystemUI at the bottom includes a navigation bar and a status bar.

Diagnosis homepage: Diagnosis homepage key.

VCI: Vehicle communication interface key. The key has two statuses, one being a disconnected VCI status and the other being a connected VCI status.

Diagnosis key: Diagnosis key (Diagnose). The key has two statuses, one being not entering a vehicle diagnostic status and the other being entering a vehicle diagnostic status.

Guard against theft key: Guard against theft key (Guard Against Theft). The key has two statuses, one being not entering a guard against theft key-cutting status and the other being entering a guard against theft key-cutting status.

Repair and maintenance service key: Repair and maintenance service (Service). The key has two statuses, one being not entering a repair and maintenance service status and the other being entering a repair and maintenance service status.

In this embodiment of the present invention, a status of hardware or software in the terminal may include but is not limited to: a screen size of the terminal (for example, a length of a short side, a length of a diagonal, and a resolution ratio), a screen placement status of the terminal (a horizontal screen status or a vertical screen status), whether the terminal has a specified function (for example, a guard against theft function), whether specified software is installed (for example, a browser), whether specified hardware is included (for example, a camera, a volume key and a VCI), whether a specified device is connected (for example, a tire pressure sensor), a status of a currently specified function (for example, an available status or an unavailable status), a status of currently specified software, a status of currently specified hardware and the like.

In this embodiment of the present invention, in step 102, the adaptively adjusting a navigation bar of the system user interface includes at least one of the following:

displaying or hiding the navigation bar;

displaying or hiding one or more navigation keys in the navigation bar; and

displaying different statuses of the navigation key.

That is, there may be different layouts of the navigation bar according to different statuses of the current terminal.

In this embodiment of the present invention, the displaying different statuses of the navigation key includes: changing a display effect, such as a display color or a shape, of the navigation key, or superimposing a status icon or a sign on the navigation key.

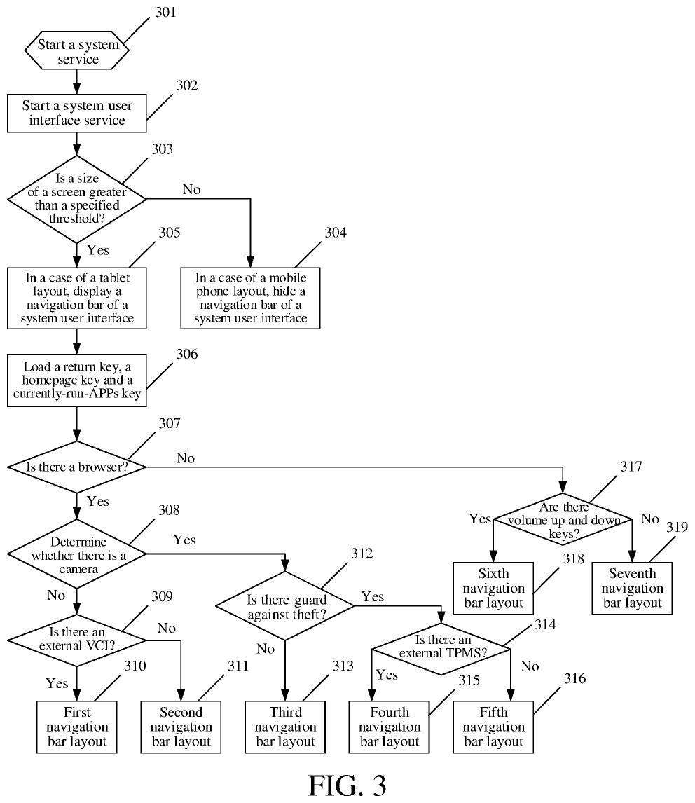

FIG. 3 is a flowchart of displaying a layout of a navigation bar according to an application example of the present invention, including the following steps:

Step 301. Start a system service.

Step 302. Start a system user interface service (SystemUI service).

Step 303. Determine whether a size of a screen is greater than a specified threshold, where a length of a short side may be greater than a specified length threshold, a resolution ratio is greater than a specified resolution ratio threshold or a length of a diagonal is greater than a specified length threshold, and the like. If not, perform step 304, and if yes, perform step 305.

Step 304. If a mobile phone layout is determined, hide a navigation bar of a system user interface, and end the procedure.

Step 305. If a tablet layout is determined, display the navigation bar of the system user interface.

Step 306. Load a return key, a homepage key and a recently-run-APPs key.

Step 307. Determine whether there is a browser, if yes, perform step 308, and if not, perform step 317.

Step 308. Determine whether there is a camera (webcam), if not, perform step 309, and if yes, perform step 312.

Step 309. Determine whether there is an external VCI, if yes, perform step 310, and if not, perform step 311.

Step 310. Display a first navigation bar layout.

Step 311. Display a second navigation bar layout.

Step 312. Determine whether there is a guard against theft function, if yes, perform step 314, and if not, perform step 313.

Step 313. Display a third navigation bar layout.

Step 314. Determine whether there is an external TPMS, if yes, perform step 315, and if not, perform step 316.

Step 315. Display a fourth navigation bar layout.

Step 316. Display a fifth navigation bar layout.

Step 317. Determine whether there are volume up and down keys, if yes, perform step 318, and if not, perform step 319.

Step 318. Display a sixth navigation bar layout.

Step 319. Display a seventh navigation bar layout.

In this application example, a corresponding function of a navigation key can be self-adapted according to a feature of a product. For example, the navigation key can be self-adapted to be a camera & screenshot key (Camera&Shoot) or a screenshot (Shoot) key by determining whether the product is equipped with a camera. In addition, a corresponding shortcut key may alternatively be automatically added to the navigation bar according to whether the product has a function such as a diagnosis function, a repair and maintenance service function, a guard against theft function or a TPMS function.

In the foregoing application example, during a start, the navigation bar layout differs according to a current status of the terminal. In another embodiment, in a running process of the terminal, if a status of the terminal changes, a status of the navigation key in the navigation bar may also be changed correspondingly. For example, at least one of the navigation keys in the navigation bar is related to a connection status of an external device of the terminal, and the adaptively adjusting a navigation bar of the system user interface according to the current status of the hardware or the software in the terminal includes: correspondingly changing a display status of the navigation key related to the connection status of the external device when the connection status of the external device changes.

Description is provided below by using a VCI key as an example.

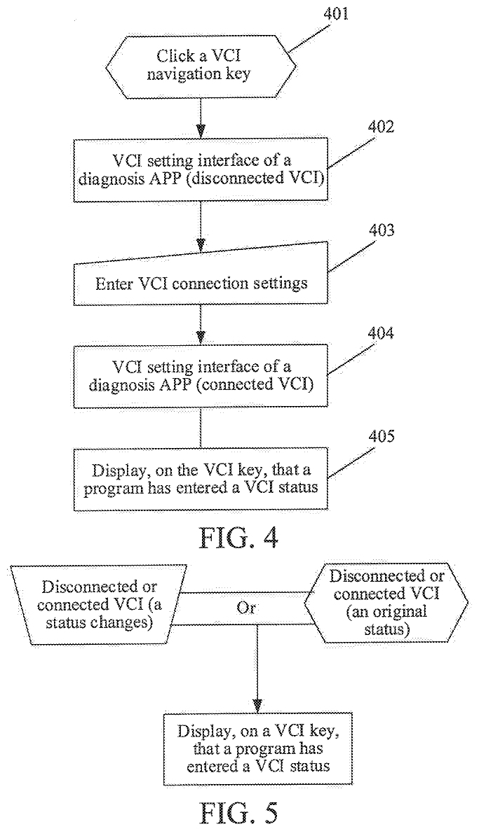

FIG. 4 is a flowchart of an operation of clicking a VCI navigation key, including:

Step 401. Click a VCI navigation key.

Step 402. Display a VCI setting interface (disconnected VCI).

Step 403. Enter VCI connection settings.

Step 404. Display a VCI setting interface (connected VCI).

Step 405. Display, on the VCI key, that a program has entered a VCI status.

In this application example, the VCI key is related to whether a vehicle communication interface device (a VCI device) is connected, when a diagnosis application is connected to the VCI or the VCI status changes, the status is sent back to the navigation key. The VCI key is clicked to jump to the VCI setting interface of the diagnosis application. When the VCI selecting a corresponding lower computer is connected successfully, a VCI icon changes from a disconnected status into a VCI connected status.

When the status of the VCI changes, and the diagnosis application receives a message and confirms that the VCI status has changed, the diagnosis application sends a broadcast to a SystemUI. After receiving the broadcast, the SystemUI updates the status on the VCI key. As shown in FIG. 5, when the status of the VCI changes (if a VCI connection has been set, when the VCI is automatically connected or disconnected by using Bluetooth, or connected or disconnected by using a USB cable), the status is reflected on a navigation key of the SystemUI.

In this embodiment of the present invention, the method further includes:

receiving an instruction of selecting a navigation key in the navigation bar, and starting a corresponding application, performing a corresponding service or displaying a corresponding dialog box according to the selected navigation key; or

receiving an instruction of selecting a navigation key in the navigation bar, and starting a corresponding application, performing a corresponding service or displaying a corresponding dialog box according to the selected navigation key and an operation mode.

In this embodiment of the present invention, when a navigation key is selected, an application may be opened or a corresponding service or another processing is performed, for example:

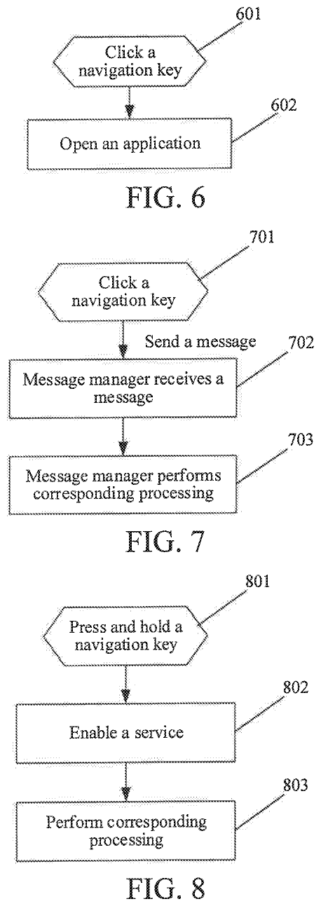

a. An application is opened or a service is enabled when a navigation key is clicked, as shown in FIG. 6, including:

Step 601. Click a navigation key.

Step 602. Open an application (or enable a service).

b. The SystemUI sends a message to a message manager when a navigation key is clicked, the message manager performing processing and displaying a dialog box, as shown in FIG. 7, including:

Step 701. Click a navigation key.

Step 702. The SystemUI sends the message to the message manager, the message manager receiving the message.

Step 703. The message manager performs corresponding processing.

For example, clicking a brightness & volume (Brightness Volume) navigation key is clicked. After receiving the message, the message manager performs processing by using a handleMessage method. In this case, a window for setting a brightness and a volume is displayed.

Furthermore, in this embodiment of the present invention, some navigation keys can perform different processing according to different operation modes, such as a click or a long press, to implement different functions.

When a navigation key is pressed and held, as shown in FIG. 8, the following steps are included:

Step 801. Press and hold a navigation key.

Step 802. Enable a service.

Step 803. The service performs application processing correspondingly.

For example, when a Camera&Shoot key is pressed and held, a system starts a TakeScreenshot Service. The service further creates a GlobalScreenshot object, and then implements a screenshot taking function through an operation corresponding to the GlobalScreenshot object. Moreover, when the Camera&Shoot key is clicked, a photographing function is implemented.

In this embodiment of the present invention, more than two navigation keys in the navigation bar have a mutually exclusive relationship. The method further includes:

operating only one of the navigation keys having the mutually exclusive relationship at a time.

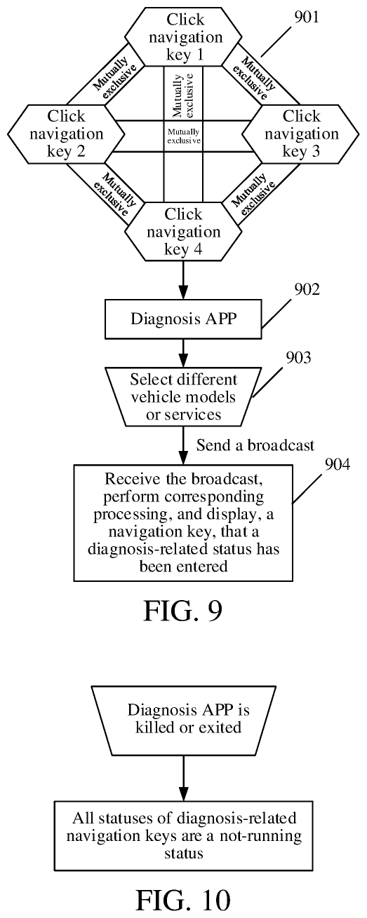

In this application example of the present invention, some diagnosis-related navigation keys not only have a function that different applications (different class) are opened by clicking navigation keys, but also have a function of feeding back corresponding statuses. When a diagnosis program enters a functional module or a status changes, the status is sent back to the navigation key. In addition, the keys are in a mutually exclusive relationship. For example, for some diagnosis-related keys in this application example of the present invention: a diagnosis key, a repair and maintenance service key (service), a tire pressure monitoring system (TPMS) key, and a guard against theft key, only one key can be operated at a time. When any of the keys is clicked or pressed to enter a corresponding function, other keys cannot be clicked. If it is desired to click any of the other keys, current diagnosis or a current service needs to be exited first. As shown in FIG. 9, when any of diagnosis-related mutually exclusive navigation keys is clicked, the following steps are included:

Step 901. Click a navigation key in a navigation bar, where the navigation key may be a navigation key 1, a navigation key 2, a navigation key 3 and a navigation key 4, where the navigation key 1, the navigation key 2, the navigation key 3 and the navigation key 4 are in a mutually exclusive relationship.

Step 902. Open a diagnosis APP.

Step 903. Select different vehicle models or services.

Step 904. Receive a broadcast, perform corresponding processing, and display, on the navigation key, that a specific diagnosis-related status has been entered.

For example:

a. If a diagnosis (Diagnose) navigation key is clicked, a system opens a diagnosis (Diagnose) interface of a diagnosis application and then selects a vehicle model according to a vehicle logo to perform diagnosis. Moreover, during the diagnosis, the diagnosis (Diagnose) navigation key is displayed in a status that vehicle diagnosis is being performed.

b. If a repair and maintenance service navigation key is clicked, the system opens a repair and maintenance service (Service) interface of the diagnosis application and then selects functions to enter different repair and maintenance service functions. During a repair and maintenance service (Service), the repair and maintenance service (Service) navigation key is displayed in a status that the repair and maintenance service is being performed.

c. If a tire pressure monitoring system (TPMS) navigation key is clicked, the system opens a TPMS interface of the diagnosis application and then selects a vehicle logo to enter TPMS diagnosis. During the TPMS diagnosis, the TPMS navigation key is displayed in a status that the TPMS diagnosis is being performed.

d. If a guard against theft (Guard Against Theft) navigation key is clicked, the system opens a guard against theft application interface of the diagnosis application and then selects a vehicle logo to enter a guard against theft function. When performing a guard against theft application operation, the guard against theft navigation key is displayed in a status where guard against theft key-cutting is being performed.

When the corresponding diagnosis is exited or the diagnosis APP is killed, a corresponding status is displayed. As shown in FIG. 10, statuses of diagnosis-related keys (for example, a diagnosis key, a VCI key, a TPMS key, a repair and maintenance service key and a guard against theft key in this application example) on a navigation bar change from a connected status to a disconnected status.

Furthermore, in the diagnosis-related navigation keys, the VCI key is related to whether a connection to an external VCI device is established, and is not mutually exclusive with another diagnosis-related navigation key. When a diagnosis application is connected to the VCI or a VCI status changes, the status is sent back to the navigation key.

Compared with the prior art, in an embodiment of the present invention, more navigation keys are adopted. Instead of being clicked step by step, related applications can be directly jumped to through the navigation keys, so that an operation is more convenient and efficient. Furthermore, a running status of related software can be reflected more directly by displaying different statuses of the navigation key. For example, when a diagnosis APP is run in the background, a user can determine more easily which diagnosis-related function is currently used, for example, whether diagnosis or a repair and maintenance service is performed, or whether TPMS diagnosis or a guard against theft key-cutting function is used. Additionally, only one of the navigation keys having the mutually exclusive relationship can be operated at a time, so that a software operation is more simple and comprehensible.

It should be noted that the foregoing are merely the embodiments or the application examples of the present invention. For example, because the foregoing application examples mainly reflect a vehicle diagnostic status, the diagnosis APP used for diagnosis is shown in FIG. 2. However, the present invention is not limited thereto. In another embodiment, another APP may be set in a main interface of a terminal, and another navigation key is set in a navigation bar. Furthermore, the navigation keys in the navigation bar may have other types, functions and layouts (for example, sizes, positions, and an order of the navigation keys). This is not limited to the navigation keys in the present application or the layout shown in FIG. 2.

Furthermore, a return status position of the navigation key may be set according to needs. For example, the return status position may be a same position of a same key, or another related key may be adopted to reflect a return status. In addition, content of the return status may be set according to needs. For example, a currently diagnosed vehicle model, a currently diagnosed Electronic Control Unit (ECU) or the like may be returned to. For the VCI key, a connection type of the VCI may be further returned to, for example, a USB connection, a Bluetooth connection or another connection manner. In this case, there are more than two or possibly several statuses that can be returned to.

For mutually exclusive navigation keys, in another embodiment, different navigation keys may be adopted as mutually exclusive keys. Mutually exclusive relationships may also be different.

An embodiment of the present invention further provides an implementation apparatus of a system user interface. The apparatus is configured to implement the foregoing embodiments and implementations. Details that have been described are not described again.

The implementation apparatus of a system user interface of this embodiment of the present invention includes: a memory, a processor and a computer program stored in the memory and executable on the processor, where when executing the program, the processor implements the following steps:

detecting a current status of hardware or software in a terminal; and

adaptively adjusting a navigation bar of the system user interface according to the current status of the hardware or the software in the terminal.

In this embodiment of the present invention, adaptively adjusting the navigation bar of the system user interface makes use of the system user interface more convenient and improves user experience.

In an implementation, when executing the program, the processor adaptively adjusts the navigation bar of the system user interface by adopting at least one of the following manners:

displaying or hiding the navigation bar;

displaying or hiding one or more navigation keys in the navigation bar; and

displaying different statuses of the navigation key.

In an implementation, when executing the program, the processor further implements:

receiving an instruction of selecting a navigation key in the navigation bar, and starting a corresponding application, performing a corresponding service or displaying a corresponding dialog box according to the selected navigation key; or

receiving an instruction of selecting a navigation key in the navigation bar, and starting a corresponding application, performing a corresponding service or displaying a corresponding dialog box according to the selected navigation key and an operation mode.

In an implementation, the operation mode includes a click and a long press.

In an implementation, more than two navigation keys in the navigation bar have a mutually exclusive relationship, where when executing the program, the processor further implements:

operating only one of the navigation keys having the mutually exclusive relationship at a time.

At least one of the navigation keys in the navigation bar is related to a connection status of an external device of the terminal, and when executing the program, the processor further implements the following:

In an implementation, a display status of the navigation key related to the connection status of the external device is correspondingly changed when the connection status of the external device changes.

In an implementation, the navigation key includes at least one of the following:

a browser key, a camera & screenshot key, a brightness & volume key, a diagnosis homepage key, a vehicle communication interface VCI key, a diagnosis key, a repair and maintenance service key, a guard against theft key and a TPMS key.

Compared with the prior art, in an embodiment of the present invention, more navigation keys are adopted. Instead of being clicked step by step, related applications can be directly, jumped to through the navigation keys, so that an operation is more convenient and efficient. Furthermore, a running status of related software can be reflected more directly by displaying different statuses of the navigation key. For example, when a diagnosis APP is run in the background, a user can determine more easily which diagnosis-related function is currently used, for example, whether diagnosis or a repair and maintenance service is performed, or whether TPMS diagnosis or a guard against theft key-cutting function is used. Additionally, only one of the navigation keys having the mutually exclusive relationship can be operated at a time, so that a software operation is more simple and comprehensible.

An embodiment of the present invention further provides an implementation apparatus of a system user interface. The apparatus is configured to implement the foregoing embodiments and implementations. Details that have been described are not described again. For example, the term “module” used below may be a combination of software and/or hardware implementing a preset function. Even if an apparatus described in the following embodiments may be implemented by software, hardware or a combination of software and hardware may also be conceived of.

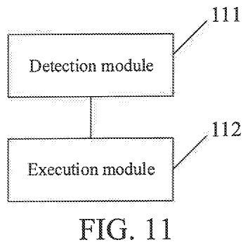

As shown in FIG. 11, an implementation apparatus of a system user interface according to an embodiment of the present invention includes:

a detection module 111, configured to detect a current status of hardware or software in a terminal; and

an execution module 112, configured to adaptively adjust a navigation bar of a system user interface according to the current status of the hardware or the software in the terminal.

In this embodiment of the present invention, adaptively adjusting the navigation bar of the system user interface makes use of the system user interface more convenient and improves user experience.

In an implementation, the execution module 112 is further configured to adopt at least one of the following manners to adaptively adjust the navigation bar of the system user interface:

displaying or hiding the navigation bar;

displaying or hiding one or more navigation keys in the navigation bar; and

displaying different statuses of the navigation key.

In an implementation, the execution module 112 is further configured to:

receive an instruction of selecting a navigation key in the navigation bar, and starting a corresponding application, performing a corresponding service or displaying a corresponding dialog box according to the selected navigation key; or

receive an instruction of selecting a navigation key in the navigation bar, and starting a corresponding application, performing a corresponding service or displaying a corresponding dialog box according to the selected navigation key and an operation mode.

In an implementation, the operation mode includes a click and a long press.

In an implementation, more than two navigation keys in the navigation bar have a mutually exclusive relationship. The execution module 112 is further configured to operate only one of the navigation keys having the mutually exclusive relationship at a time.

In an implementation, at least one of the navigation keys in the navigation bar is related to a connection status of an external device of the terminal. The execution module 112 is further configured to change a display status of the navigation key related to the connection status of the external device when the connection status of the external device changes.

In an implementation, the navigation key includes at least one of the following:

a browser key, a camera & screenshot key, a brightness & volume key, a diagnosis homepage key, a vehicle communication interface VCI key, a diagnosis key, a repair and maintenance service key, a guard against theft key and a TPMS key.

Compared with the prior art, in an embodiment of the present invention, more navigation keys are adopted. Instead of being clicked step by step, related applications can be directly jumped to through the navigation keys, so that an operation is more convenient and efficient. Furthermore, a running status of related software can be reflected more directly by displaying different statuses of the navigation key. For example, when a diagnosis APP is run in the background, a user can determine more easily which diagnosis-related function is currently used, for example, whether diagnosis or a repair and maintenance service is performed, or whether TPMS diagnosis or a guard against theft key-cutting function is used. Additionally, only one of the navigation keys having the mutually exclusive relationship can be operated at a time, so that a software operation is more simple and comprehensible.

An embodiment of the present invention further provides a computer-readable storage medium. In this embodiment of the present invention, the computer-readable storage medium may be set to store a computer-executable instruction used to perform the following steps:

S1. Detect a current status of hardware or software in a terminal.

S2. Adaptively adjust a navigation bar of the system user interface according to the current status of the hardware or the software in the terminal.

In an implementation, the adaptively adjusting a navigation bar of the system user interface includes at least one of the following:

displaying or hiding the navigation bar;

displaying or hiding one or more navigation keys in the navigation bar; and

displaying different statuses of the navigation key.

In an implementation, the computer-readable storage medium is further set to store a computer-executable instruction used to perform the following step:

receiving an instruction of selecting a navigation key in the navigation bar, and starting a corresponding application, performing a corresponding service or displaying a corresponding dialog box according to the selected navigation key; or

receiving an instruction of selecting a navigation key in the navigation bar, and starting a corresponding application, performing a corresponding service or displaying a corresponding dialog box according to the selected navigation key and an operation mode.

In an implementation, the operation mode includes a click and a long press.

In an implementation, more than two navigation keys in the navigation bar have a mutually exclusive relationship. The computer-readable storage medium may further be set to store a computer-executable instruction used to perform the following step:

operating only one of the navigation keys having the mutually exclusive relationship at a time.

In an implementation, the computer-readable storage medium is further set to store a computer-executable instruction used to perform the following step:

correspondingly changing a display status of the navigation key related to the connection status of the external device when the connection status of the external device changes.

In an implementation, the navigation key includes at least one of the following:

a browser key, a camera & screenshot key, a brightness & volume key, a diagnosis homepage key, a vehicle communication interface VCI key, a diagnosis key, a repair and maintenance service key, a guard against theft key and a tire pressure monitoring system TPMS key.

In this embodiment of the present invention, the computer-readable storage medium may include but is not limited to: various mediums capable of storing program code such as a USB flash drive, a read-only memory (ROM), a random access memory (RAM), a mobile hard disk drive, a magnetic disk or an optical disc.

For an example in this embodiment, refer to the examples described in the foregoing embodiments and the implementations. Details are not described again in this embodiment.

This embodiment further provides an implementation apparatus of a system user interface, including a processor, where the processor is configured to implement functions of the foregoing detection module 111 and the execution module 112. Specifically, the following process is performed: detecting a current status of a terminal; and adaptively adjusting a navigation bar in a system user interface according to the current status of the terminal.

Apparently, a person skilled in the art should understand that the modules or steps in the embodiments of the present invention may be implemented by using a general-purpose computing device, and may be centralized on a single computing device or distributed on a network including a plurality of computing devices. Optionally, they may be implemented by program code executable on a computing device, so that they can be stored in a storage device and executed by a computing device. In addition, in some cases, the steps shown or described may be performed in an order different from the order herein. Alternatively, they are separately manufactured into integrated circuit modules, or a plurality of modules or steps in them are manufactured into a single integrated circuit module for implementation. The embodiments of the present invention are not limited to any specific combination of hardware and software.

Although implementations disclosed in the present invention are stated above, the described contents are merely implementations adopted to help understand the present invention, and are not intended to limit the present invention. Any person skilled in the art of the present invention can make any modifications and variations to forms and details of implementation without departing from the spirit and scope disclosed in the present invention. However, the protection scope of the present invention is subject to the scope defined the appended claims.

What is claimed is:

1. An implementation method of a system user interface, comprising:
detecting a current status of hardware or software in a terminal; and
adaptively adjusting a navigation bar of the system user interface according to the current status of the hardware or the software in the terminal.

2. The method according to claim 1, wherein the adaptively adjusting a navigation bar of the system user interface comprises at least one of the following:
displaying or hiding the navigation bar;
displaying or hiding one or more navigation keys in the navigation bar; and
displaying different statuses of the navigation key.

3. The method according to claim 1, further comprising:
receiving an instruction of selecting a navigation key in the navigation bar, and starting a corresponding application, performing a corresponding service or displaying a corresponding dialog box according to the selected navigation key; or
receiving an instruction of selecting a navigation key in the navigation bar, and starting a corresponding application, performing a corresponding service or displaying a corresponding dialog box according to the selected navigation key and an operation mode.

4. The method according to claim 3, wherein
the operation mode comprises a click and a long press.

5. The method according to claim 1, wherein more than two navigation keys in the navigation bar have a mutually exclusive relationship, the method further comprising:
operating only one of the navigation keys having the mutually exclusive relationship at a time.

6. The method according to claim 1, wherein at least one of the navigation keys in the navigation bar is related to a connection status of an external device of the terminal, and the adaptively adjusting a navigation bar of the system user interface according to the current status of the terminal comprises:
correspondingly changing a display status of the navigation key related to the connection status of the external device when the connection status of the external device changes.

7. The method according to claim 2, wherein the navigation key comprises at least one of the following:
a browser key, a camera & screenshot key, a brightness & volume key, a diagnosis homepage key, a vehicle communication interface VCI key, a diagnosis key, a repair and maintenance service key, a guard against theft key and a tire pressure monitoring system TPMS key.

8. An implementation apparatus of a system user interface, comprising: a memory, a processor and a computer program stored in the memory and executable on the processor, wherein when executing the program, the processor implements the following steps:
detecting a current status of hardware or software in a terminal; and
adaptively adjusting a navigation bar of the system user interface according to the current status of the hardware or the software in the terminal.

9. The apparatus according to claim 8, wherein when executing the program, the processor adaptively adjusts the navigation bar of the system user interface by adopting at least one of the following manners:
displaying or hiding the navigation bar;
displaying or hiding one or more navigation keys in the navigation bar; and
displaying different statuses of the navigation key.

10. The apparatus according to claim 8, wherein when executing the program, the processor further implements:
receiving an instruction of selecting a navigation key in the navigation bar, and starting a corresponding application, performing a corresponding service or displaying a corresponding dialog box according to the selected navigation key; or
receiving an instruction of selecting a navigation key in the navigation bar, and starting a corresponding application, performing a corresponding service or displaying a corresponding dialog box according to the selected navigation key and an operation mode.

11. The apparatus according to claim 8, wherein more than two navigation keys in the navigation bar have a mutually exclusive relationship, and when executing the program, the processor further implements:
operating only one of the navigation keys having the mutually exclusive relationship at a time.

12. The apparatus according to claim 8, wherein at least one of the navigation keys in the navigation bar is related to a connection status of an external device of the terminal, and when executing the program, the processor further implements:
correspondingly changing a display status of the navigation key related to the connection status of the external device when the connection status of the external device changes.

13. A computer-readable storage medium, storing a computer-executable instruction, wherein the computer-executable instruction is used to detect a current status of hardware or software in a terminal; and adaptively adjust a navigation bar of the system user interface according to the current status of the hardware or the software in the terminal.
